(19) United States
(12) Patent Application Publication
(10) Pub. No.: US 2025/0283785 A1
(43) Pub. Date: Sep. 11, 2025

(54) Active Control System for Damage Stability Test of Ships

(71) Applicant: HUA RONG RADIO AND TELEVISION TECHNOLOGY SOCIETY, Yueyang City (CN)

(72) Inventors: Tie YU, Yueyang City (CN); Jieyu YU, Yueyang City (CN); Yaojie YAN, Yueyang City (CN); Jian ZHANG, Yueyang City (CN); Kai XU, Yueyang City (CN); Liu YU, Yueyang City (CN); Jiawei XU, Yueyang City (CN); Yang ZHOU, Yueyang City (CN)

(21) Appl. No.: 19/215,670

(22) Filed: May 22, 2025

Related U.S. Application Data
(63) Continuation of application No. PCT/CN2022/133848, filed on Nov. 23, 2022.

(30) Foreign Application Priority Data
Nov. 22, 2022 (CN) 202211462689.0

(51) Int. Cl. G01M 99/00; B63B 71/00

(52) U.S. Cl. CPC G01M 99/00; B63B 71/00

(57) ABSTRACT

In this invention, an active control system for ship rupture stability testing is disclosed, consisting of a hull (1), said hull (1) has a number of through holes (2) uniformly distributed across the impact zone, the through-holes (2) are fitted with valves and sensing devices, and the communication is connected to a control device (3), in addition, the hull cabin (1) is connected to a negative-pressure device (4); the control device (3) controls the opening and closing of the valve matrix combinations of different through holes (2) The control device (3) controls the opening and closing of the valve matrix combinations in the different through holes (2) to simulate the actual impact ports in different shapes and positions on the hull (1); the negative pressure device (4) is used to provide negative pressure to make the inlet water flow of the impact port area of the test model and the inlet water flow of the actual impact port area with an error of less than 1%. In this invention, the simulation of different shock port shapes can be realized by controlling the opening of valve die combinations in different zone shapes; for the negative pressure device, it is realized that the valve array combinations converge with the flow rate of the actual vessel's breach port, improving the accuracy of the test.

### CROSS-REFERENCE TO RELATED APPLICATIONS

The present application is a continuation of International (PCT) Patent Application No. PCT/CN2022/133848, filed on Nov. 23, 2022, which claims the priority of Chinese patent application No. 202211462689.0, filed on Nov. 22, 2022. The entire contents of International (PCT) Patent Application No. PCT/CN2022/133848 and Chinese patent application No. 202211462689.0 are hereby incorporated by reference in their entireties.

### TECHNICAL FIELD

This invention is related to the ship's mechanical stability testing areas, specifically the ship damage stability testing of the active control system.

### TECHNICAL BACKGROUND

The stability of vessel damage is an important performance measure of vessel navigation safety, when a ship due to accidents such as collision, grounding, rocks the ship sinks, or capsizes posed a serious threat to the safety of the ship's navigation, such as the need for ship damage stability simulation calculation and model testing, the overall plan, and the need for additional model test apparatus.

### SUMMARY

To address the aforementioned technical issues, this invention proposes an active control system for ship rupture stability testing.

The following technical solutions are used to realize the objects of this invention:

An active control system for a ship breaking stability test, including a ship hull, stated that the hull of the ship is provided with a number of impact zones; the impact area is uniformly distributed with a number of through-holes, the through-holes are fitted with valves, the hull of the ship is fitted with a water level detection device in the cabin, and the communication is connected to a control device, and the cabin of the ship hull is also connected with a negative pressure device; the different through-holes are assembled to form matrix combinations, and the control device controls valves in the through-holes in the different matrix combinations to simultaneously The control device controls the valves in the through-holes of different matrix combinations to open and close simultaneously to simulate different shapes of the simulated impact port area on the hull to form a shape consistent with the actual impact port required for the test; the negative pressure device is used to provide negative pressure to make the water inlet flow of the simulated impact port area consistent with the water inlet flow of the actual impact port required for the test.

Another improvement, said hull impact zone includes the port side, bow, forward, middle and aft parts of the stern, top, middle and bottom parts as well as the bow, the mid and aft portions of the bottom of the hull, the port and starboard portions, or the areas of impact of the hull are distributed evenly over the hull.

Another improvement, said control device, is a computer, a smart phone, or an IPAD.

Another improvement is to say that the valve is a solenoid valve, and that the solenoid valve is connected to the control device by wireless communication.

Further improvement, said sensing device is a water level sensing device, and the water level sensing device is wirelessly communicatively connected to the control device.

Another improvement, called through-hole, is positive polygonal, circular, or irregular in shape.

To further improve, the said water inlet flow rate of said simulated impingement port area has an error of less than 1% compared to the water inlet flow rate of the actual impingement port needed for the experiment.

Another improvement, stated that the negative pressure device is an air-water mixture pump.

Another improvement, stated that the negative pressure device is also used to drain water from the cabin.

To further improve, the stated system requires error correction prior to use.

This invention has the following beneficial effects:

By controlling the combination of the opening and closing die of the valve, different shapes and positions of the gap opening are achieved.

Performing the simulation of different gap shapes broken by a negative pressure device in order to maintain the consistency of its inlet water flow and the actual shock gap flow, to reduce the error between the test model and the actual shock aperture, and to improve the accuracy of the test.

Setting up multiple impact-prone areas, or setting up the ship's side, bow, stern key parts and all as impact-prone areas to simulate the situation where different parts of the ship's hull are broken or multiple areas are broken at the same time.

Save the cost of test equipment and the energy consumption of artificial waves required for the test.

It can be used for other trials such as sail performance, hydrostatic performance and an active control system that can be inverted to the ship rupture instability test after the ship has ruptured.

### BRIEF DESCRIPTION OF DRAWINGS

Further description of the invention is provided using the accompanying drawings, but nothing in the accompanying drawings is a limitation of the invention.

FIG. 1 shows a schematic of the general structure of this invention.

where (1) the shell, (2) the impact zone through the hole, (3) the control device, (4) the negative pressure device

### DETAILED DESCRIPTION

So that the objects, technical solutions, and benefits of the invention are clearer and more comprehensible, a more detailed description of the invention is given below in conjunction with accompanying drawings and examples.

### Implementation Example 1

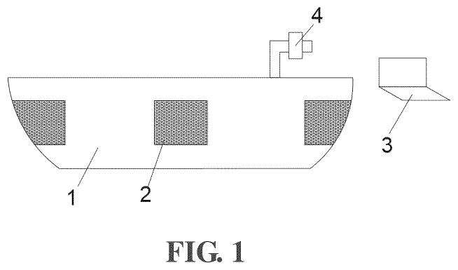

The active control system for the ship breaking stability test consists of a hull 1, as shown in FIG. 1, for the impact portion of said shell 1, there are a number of through holes 2 uniformly distributed, through holes 2 have solenoid valves and water-level sensors, the solenoid valves and the water level sensors are connected to the communication with a remote control device 3, and hull 1's cabin is also connected with a negative-pressure device 4; control 3 controls the opening and closing of the valves of the different through holes 2 in the die combination in order to simulate the required area of the impact port on the differently shaped shell 1. Control 3 controls the combination of valve opening and closing dies in different through holes 2 to simulate different test shapes needed for the area of the impact port on shell 1; a negative pressure device 4 is used to provide a negative pressure to make the simulation of the impact port area of the inlet water flow as well as the required test for the inlet water flow error less than 1%. When the water level-sensing device detects that the intake of water from the ship's compartment reaches a predetermined amount, when the negative pressure device 4 returns to the initial state, the simulated vessel breaking the inflow process terminates.

### Implementation Example 2

The system must be error corrected before using the present invention to ensure that the error between the flow rate of the model run and that required for the run is less than 1%; at the same time, since the system is operated at different times, places, etc., ambient temperatures, water temperatures, and barometric pressures will vary, and must also be corrected for errors. Calibration steps include:
an experimental control hull is set up to be placed in the water, the experimental shell is fitted with a gate and then the gate is opened to a pre-set aperture size, and the flow rate of the incoming water and the time in the hull are measured and recorded.
the invention of shell 1 corresponding to the pre-set apertures area above the through hole 2 in the valve is opened, and to start the negative pressure device 4, so as to cause the water to flow into the cabin and the time, and the same as the experimental water flow hull, recorded at that time the negative pressure device 4 negative pressure value, i.e., the calibration of the test of the reference value.
at the same time pre-set a plurality of aperture areas, and then repeat step 2, increasing the open position and number of records through the 2-hole valve.

### Implementation Example 3

The first shell of the present invention is used to perform a breakthrough test. Hull 1 is placed on the surface of the water and then based on the size and shape of the break opening to be simulated, the valve on hole 2 through the corresponding area is opened by remote control device 3, and the negative pressure device is set based on the position and number of valves open, in order for the cabin to reach the reference negative pressure value of the corresponding calibration system, and then perform the ship's stability test for breakage, or other tests such as the performance of the sail or the hydrostatic performance of the ship after breakage has occurred. Therein, the position and surface area of the valve opening can be adjusted at any time as required, in order to perform the simulation of different rupture areas, rupture sizes, and rupture shapes, in order to speed up the simulation test speed and reduce power consumption.

Where the impact region of hull 1 includes the outer side of the hull, the bow of the hull, the rear of the hull including the fore, mid and aft parts, the upper, middle and lower parts as well as the bow, the middle and part of the lower hull 1, the left and right portions, or to perform mounting of other regions, either to evenly distribute hull 1's impact area over hull 1 or to perform mounting of other regions as needed.

Control devices 3 are computers, smart phones, or IPADs.

A solenoid valve is used, and the solenoid valve is connected to the control device 3 via a wireless communication system.

The through hole 2 is square polygonal, circular, or irregular in shape.

The inlet flow error between the simulated impact port area and the actual impact port area is less than 1%.

Negative pressure unit 4 is an air-water mixing pump.

Negative pressure device 4 is also applied to drain water from the cabin at the end of the test.

### Implementation Example 4

Current speed sensor have also been installed outside the ship to measure the relative speed between the ship and the current, to test the stability of the ship in the event of breakage and leakage at different relative speeds or speeds, and to test the maximum distance and optimal speed of the ship after the breakage.

### Implementation Example 5

Active control system for ship breakage stability tests, reversibly applied to an active control system for ship breakage instability tests, with the (former passive) impact area replaced by the (new active guided target) impact area, and the (former passive) through-hole 2 by the (new baseline equivalent action effect and range) through-hole 2, all else unchanged.

### Implementation Example 6

Active control system of ship breakage stability tests to verify the new European modular ship “almost unsinkable” breakage stability.

Finally, it is important to note that the above embodiments are used only to illustrate the technical scheme of the invention and not to limit the protective scope of the invention. While the invention has been described in detail with reference to preferred embodiments, general technicians engaged in the industry should understand that the technical scheme of the invention can be modified or substituted in an equivalent manner without deviating from the substance and scope of the technical scheme.

1. Active control system for ship breaking stability test, including a hull, wherein the hull is provided with a number of impact zones, the impact zones of the hull are uniformly distributed in the hull; the impact zones are uniformly distributed with a number of through holes, each of the through-holes is circular, the through holes are equipped with valves, a water level sensing device is disposed in a cabin of the hull and is connected to a control device by communication, and the cabin of the hull is connected with a negative pressure device, different sets of the through holes form a matrix combination, and the control device controls the valves in different matrix combinations to open and close simultaneously to simulate different shapes of simulated impact port areas on the hull, the different sets of the through holes together form a matrix combination, the control device controls the matrix combination of the through holes in the valves at a same time to open and close in order to simulate different shapes of the simulated impact port areas on the hull, and in order to form a shape of an actual impact port required for the ship breaking stability test, a negative pressure device is used to provide a negative pressure to make a simulation of an impact port area of an incoming flow of water and a test of the actual impact port incoming flow of water to converge with an actual impingement port inlet flow required for the ship breaking stability test.

2. The active control system for ship breaking stability test as claimed in claim 1, wherein the negative pressure device is an air-water mixing pump, and the negative pressure device is also applied to drain a compartment of a ship at an end of the ship breaking stability test.
